(19) United States
(12) Patent Application Publication
(10) Pub. No.: US 2024/0244697 A1
(43) Pub. Date: Jul. 18, 2024

(54) Electronic device and Bluetooth communication method having automatic re-connection activating mechanism

(71) Applicant: Suzhou PanKore Integrated Circuit Technology Co. Ltd., Suzhou City (CN)

(72) Inventors: XIAO-DAN XU, Suzhou (CN); SHI-QIANG ZHAI, Suzhou (CN); SI-YUAN WANG, Suzhou (CN)

(21) Appl. No.: 18/210,667

(22) Filed: Jun. 16, 2023

(30) Foreign Application Priority Data
Jan. 18, 2023 (CN) 202310066467.5

(51) Int. Cl. H04W 76/19; H04W 4/06

(52) U.S. Cl. CPC H04W 76/19; H04W 4/06

(57) ABSTRACT

The present disclosure discloses a Bluetooth communication method having automatic re-connection activating mechanism that includes steps outlined below. A first broadcast signal is transmitted by an electronic device such that a smart device receives and identifies the electronic device as a terminal device. An initial connection is established and pairing is performed with the smart device by the electronic device such that the smart device stores device related information of the electronic device. A second broadcast signal is transmitted by the electronic device such that the smart device receives the second broadcast signal and identifies the electronic device according to the device related information to further activate an auto-connection application program according to positioning beacon information included in the second broadcast signal. A connection request delivered by the auto-connection application program of the smart device is received by the electronic device to re-establish connection with the smart device.

### BACKGROUND OF THE INVENTION

### 1. Field of the Invention

The present disclosure relates to an electronic device and a Bluetooth communication method having automatic re-connection activating mechanism.

### 2. Description of Related Art

Along with the development of Internet of Thing (IoT) technology, a smart device can use Bluetooth wireless technology to control electronic devices, e.g. home appliances and electronic automobiles, to perform electronic switching or electronic unlocking. The wide variety of application makes such a technology popular. For example, the electronic devices may establish connection with an approaching smart device by using the Bluetooth technology and switch on illumination or perform electronic unlocking according to the Bluetooth technology.

However, for the smart devices on the market, when these smart devices are supposed to establish re-connection with the electronic devices, manual operation is required to be performed on the smart devices to switch the smart device from a sleep (standby) mode to an operation mode such that the smart device establishes Bluetooth connection under the operation mode so as to switch on illumination or perform electronic unlocking subsequently. When the electronic device can perform automatic reconnection and activation mechanism under the sleep (standby) mode instead of the operation mode, not only no additional cost is required, but also power consumption of the smart device can be reduced when the re-connection can be established under the sleep (standby) mode of the smart device and/or without the need to be operated under the operation mode of the smart device.

### SUMMARY OF THE INVENTION

In consideration of the problem of the prior art, an object of the present disclosure is to provide an electronic device and a Bluetooth communication method having automatic re-connection activating mechanism.

The present invention discloses a Bluetooth communication method having automatic re-connection activating mechanism that includes steps outlined below. A first broadcast signal is transmitted by an electronic device such that a smart device receives the first broadcast signal and identifies the electronic device as a terminal device according to the first broadcast signal. An initial connection is established and pairing with the smart device is performed by the electronic device such that the smart device stores device related information of the electronic device. A second broadcast signal is transmitted by the electronic device such that the smart device receives the second broadcast signal and identifies the electronic device according to the second broadcast signal based on the device related information to further activate an auto-connection application program according to positioning beacon information comprised in the second broadcast signal. A connection request delivered by the auto-connection application program of the smart device is received by the electronic device to establish a re-connection with the smart device.

The present invention also discloses an electronic device having automatic re-connection activating mechanism that includes a communication circuit and a processing circuit. The processing circuit is configured to perform steps outlined below. A first broadcast signal is transmitted by using the communication circuit such that a smart device receives the first broadcast signal and identifies the electronic device as a terminal device according to the first broadcast signal. An initial connection is established and pairing with the smart device is performed by using the communication circuit such that the smart device stores device related information of the electronic device. A second broadcast signal is transmitted by using the communication circuit such that the smart device receives the second broadcast signal and identifies the electronic device according to the second broadcast signal based on the device related information to further activate an auto-connection application program according to positioning beacon information comprised in the second broadcast signal. A connection request delivered by the auto-connection application program of the smart device is received by using the communication circuit to establish a re-connection with the smart device.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of a Bluetooth communication system according to an embodiment of the present invention.

FIG. 2 illustrates a diagram of a packet of the second broadcast signal according to an embodiment of the present invention.

FIG. 3 illustrates a flow chart of a Bluetooth communication method 300 having automatic re-connection activating mechanism according to an embodiment of the present invention.

FIG. 4 illustrates a flow chart of a Bluetooth communication method used in the smart device having automatic re-connection activating mechanism according to an embodiment of the present invention.

### DETAILED DESCRIPTION OF THE PREFERRED EMBODIMENTS

An aspect of the present invention is to provide an electronic device and a Bluetooth communication method having automatic re-connection activating mechanism to activate the automatic re-connection mechanism with the smart device under a low cost condition and further avoid the issue that the smart device stops to perform re-connection when the smart device is not connected for a long time.

Reference is now made to FIG. 1. FIG. 1 illustrates a block diagram of a Bluetooth communication system 100 according to an embodiment of the present invention. The Bluetooth communication system 100 includes an electronic device 110 and a smart device 120.

Each of the electronic device 110 and the smart device 120 is equipped with Bluetooth communication ability to establish connection with each other by using Bluetooth technology and perform communication with each other.

In an embodiment, the electronic device 110 and the smart device 120 establishes connection with each other based on Bluetooth Low Energy (BLE) protocol.

The smart device 120 can be such as, but not limited to a smartphone or a tablet personal computer (PC) and store an auto-connection application program APP related to the operation of the electronic device 110 therein. The electronic device 110, after being connected with the smart device 120, may automatically execute a predetermined function (e.g., electronic switching or controlling an electronic lock) according to the operation of the auto-connection application program APP.

In a usage scenario, the electronic device 110 (e.g., an electronic door lock or an electronic automobile) is a device equipped with electronic locking and unlocking technology. After the electronic device 110 detects the connection established with the smart device 120 that verifies the electronic device 110, the automatic electronic unlocking function can be executed according to the operation of the auto-connection application program APP. In another usage scenario, the electronic device 110 is a device equipped with electronic switching illumination technology. After the electronic device 110 detects the connection established with the smart device 120 that verifies the electronic device 110, the electronic switching illumination function can be executed according to the operation of the auto-connection application program APP. However, the present invention is not limited thereto.

The smart device 120 and the electronic device 110 have an automatic re-connection activating mechanism (e.g., both support the human interface device (HID) service of the BLE protocol). When the electronic device 110 and the smart device 120 establishes initial connection, the smart device 120 verifies the electronic device 110 (i.e., the electronic device 110 is verified by the smart device 120). After the smart device 120 and the electronic device 110 are disconnected and the smart device 120 receives a connection request under a sleep mode from the electronic device 110, the smart device 120 is able to activate the auto-connection application program APP in the sleep mode to establish re-connection such that the electronic device 110 detects the connection established with the smart device 120 that verifies the electronic device 110 and activates the corresponding predetermined program to execute the predetermined function.

The configuration of the electronic device 110 is described first in detail in the following paragraphs.

The electronic device 110 includes a communication circuit 130 and a processing circuit 140. In a preferable embodiment, the electronic device 110 supports the HID service of the BLE protocol.

The communication circuit 130 can be any circuit that is configured to perform communication with the smart device 120 by using Bluetooth communication technology. The processing circuit 140 is electrically coupled to the communication circuit 130 and is configured to execute computer executable commands (not illustrated) and the computer executable commands include such as, but not limited to firmware/driver and related commands of the communication circuit 130 and other hardware modules in the electronic device 110. By executing the computer executable commands, the processing circuit 140 accesses the signal or data of the communication circuit 130 to perform operation so as to execute the function of the electronic device 110. In an embodiment, the processing circuit 140 may include a plurality of hardware circuits to execute the function of the electronic device 110 with pure hardware configuration.

The operation of the electronic device 110 is further described in detail in the following paragraphs.

Since the electronic device 110 supports BLE protocol, the processing circuit 140 transmits a first broadcast signal ADV1 by using the communication circuit 130 such that the smart device 120 receives the first broadcast signal ADV1 and establishes initial connection. After the smart device 120 verifies the electronic device 110 (i.e., the electronic device 110 is verified by the smart device 120), the smart device 120 identifies the electronic device 110 as a terminal device.

In an embodiment, the smart device 120 supports the HID service of the BLE protocol. The first broadcast signal ADV1 includes HID information of the electronic device 110 such that the smart device 120 receives the HID information and identifies the electronic device 110 as the terminal device having the HID service.

The processing circuit 140 establishes the initial connection and performs pairing with the smart device 120 by using the communication circuit 130. Under the condition that the smart device 120 supports HID service, the smart device 120 stores device related information EI of the electronic device 110.

In an embodiment, the initial connection is established based on BLE protocol. During the pairing is performed, the processing circuit 140 may exchange information with the auto-connection application program APP of the smart device 120 by using the communication circuit 130. Further, the smart device 120 may store the device related information EI of the electronic device 110 through the information exchange described above.

In an embodiment, the device related information includes identification information of the electronic device 110 that may include media access control (MAC) address, universally unique identifier (UUID) or other information that can identify the electronic device 110.

After the initial connection is established, one of the electronic device 110 and the smart device 120 may be displaced due to the movement of the user thereof such that a distance between the electronic device 110 and the smart device 120 is too large so as to break the initial connection. Under such a condition, the smart device 120 may allow the auto-connection application program APP to enter a deactivated status. It is appreciated that the deactivated status can be a fully deactivated status or a sleep status.

The processing circuit 140 transmits a second broadcast signal ADV2 by using the communication circuit 130 such that the smart device 120 receives the second broadcast signal ADV2 and identifies the electronic device 110 according to positioning beacon information (BE) included in the second broadcast signal ADV2 based on the device related information EI. Under such a condition, the smart device 120 automatically activates the auto-connection application program APP. However, under the condition that the smart device 120 does not support the HID service, the smart device 120 does not perform automatic re-connection after the second broadcast signal ADV2 is received.

In an embodiment, the content of the first broadcast signal ADV1 and the second broadcast signal ADV2 transmitted by the electronic device 110 is the same. However, under the condition that a record is made after the initial connection is established between the smart device 120 and the electronic device 110, the smart device 120 is able to perform automatic connection according based on the previously stored information.

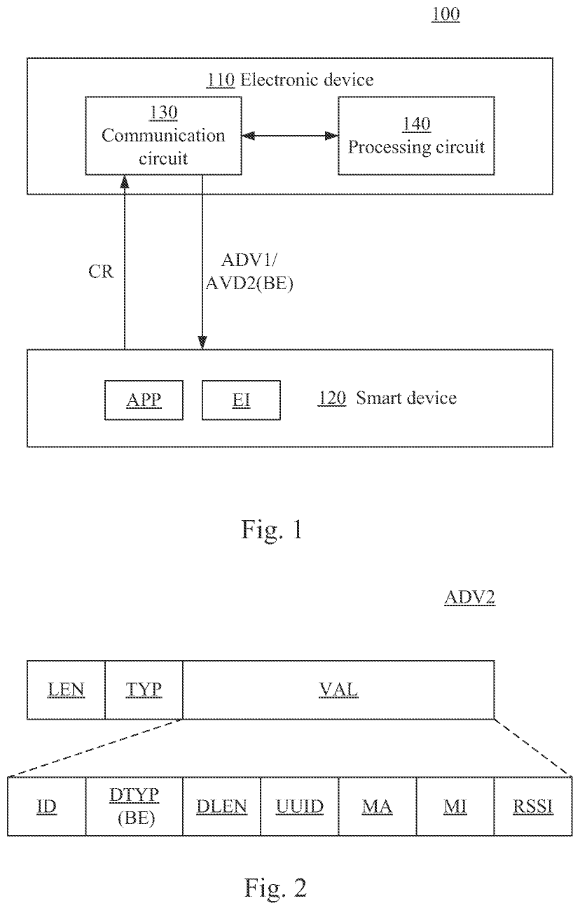

Reference is now made to FIG. 2. FIG. 2 illustrates a diagram of a packet of the second broadcast signal ADV2 according to an embodiment of the present invention. The packet of the second broadcast signal ADV2 includes such as, but not limited to a length entry LEN, a type entry TYP and a value entry VAL.

The content of the length entry LEN is used to indicate a length of the packet. The content of the type entry TYP is used to indicate a type of the packet, such as but not limited to a packet type of connectable undirected advertisement.

The content of the value entry VAL includes actual data. The value entry VAL may further include such as, but not limited to a manufacturer identification code entry ID, a data type entry DTYP, a data length entry DLEN, an identification code entry UUID, a major entry MA, a minor entry MI and a received signal strength indication entry RSSI.

The content of the manufacturer identification code entry ID is used to indicate the identification code of the manufacturer of the smart device 120 that performs communication with the electronic device 110. For example, when the smart device 120 is an iPhone of the Apple Incorporated, the content of the manufacturer identification code entry ID can be the identification code 0x004c of the Apple Incorporated.

The content of the data type entry DTYP is used to indicate the data type of the value entry VAL. The positioning beacon information BE (iBeacon) is a kind of data type of the value entry VAL. For example, when the smart device 120 is a smartphone of the Apple Incorporated, the content of the data type entry DTYP can be the value of 0x02, and such a value is used to indicate the data type of the positioning beacon information BE (iBeacon) provided by the Apple Incorporated. After the smart device 120 receives the second broadcast signal ADV2 under the sleep mode, the auto-connection application program APP that the smart device 120 corresponds to is directly activated according to the positioning beacon information BE having the value 0x2 such that the specific function is executed. The process described above allows the smart device 120 to perform automatic connection under the sleep mode without the need to switch to the operation mode before the connection is performed.

The content of the data length entry DLEN is used to indicate a length of the value entry VAL, in which the value thereof can be 0x15. However, the content of the data length entry DLEN may have difference values according to practical conditions.

The content of the identification code entry UUID has a length of such as, but not limited to 16 bits and is used to indicate the identification code corresponding to the electronic device 110, such as but not limited to a UUID code. In an embodiment, the value of the identification code entry is set by performing calculation actively by the electronic device 110. In another embodiment, the value of the identification code entry is set by receiving a calculation result of the auto-connection application program APP from the smart device 120 by the electronic device 110.

Each of the content of the major entry MA and minor entry MI has a length of such as, but not limited to 2 bits and is used to indicate the location area that the electronic device 110 is in, wherein the major entry MA corresponds to a larger range of area and the minor entry MI corresponds to a smaller range of area. The content of the received signal strength indication entry RSSI is used to indicate the strength of the signal transmitted by the electronic device 110. The configuration and the more detailed definition of these entries are described in Bluetooth standard related documents, e.g., the document of “Bluetooth Core Specification Version 5.3|Vol 3, Part C 11 Advertising and scan response data format”.

It is appreciated that the packet formats, the entry contents, the entry lengths and the entry values described above are merely an example. In different embodiments, the second broadcast signal ADV2 may include different formats, contents, length sizes and values. The present invention is not limited thereto.

By using the packet structure of the second broadcast signal ADV2 described above, the smart device 120 perform identification on the identification code entry UUID of the second broadcast signal ADV2 according to the device related information EI so as to identify the electronic device 110. Meanwhile, the smart device 120 activates the auto-connection application program APP according to the positioning beacon information BE included by the data type entry DTYP in the second broadcast signal ADV2.

The processing circuit 140 receives a connection request CR delivered by the auto-connection application program APP of the smart device 120 by using the communication circuit 130 to establish a re-connection with the smart device 120.

In an embodiment, after the auto-connection application program APP is activated, a Bluetooth connection status between the electronic device 110 and the smart device 120 is determined by the smart device 120. When the Bluetooth connection status is a disconnected status, the connection request CR is delivered by the smart device 120 such that the processing circuit 140 receives the connection request CR by using the communication circuit 130 and establishes re-connection with the smart device 120 by using the communication circuit 130. In an embodiment, the re-connection is established based on BLE protocol.

In an embodiment, the smart device 120 deactivates the auto-connection application program APP after the smart device 120 establishes the re-connection to accomplish a power-saving mechanism. On the other hand, the electronic device 110 executes a predetermined function according to the re-connection. For example, when the electronic device 110 is a device equipped with electronic locking technology and electronic unlocking technology, the predetermined function is either an electronic locking function or an electronic unlocking function. When the electronic device 110 is a device equipped with electronic switching illumination technology, the predetermined function is either an electronic switching on function or an electronic switching off function.

After the electronic device of the present invention establishes the initial connection with the smart device and is identified as the terminal device by the smart device, the electronic device of the present invention can perform re-connection with the smart device by using BLE technology under a low complexity and low cost condition. Further, the electronic device of the present invention activates the smart device to activate the auto-connection application program to establish the re-connection according to the positioning beacon information in the broadcast signal. The issue that the smart device stops to perform re-connection when the smart device is not connected for a long time can be avoided. The electronic device can thus activate the automatic re-connection mechanism with the smart device so as to execute the predetermined function based on the established re-connection. The electronic device is not needed to be operated in the operation mode.

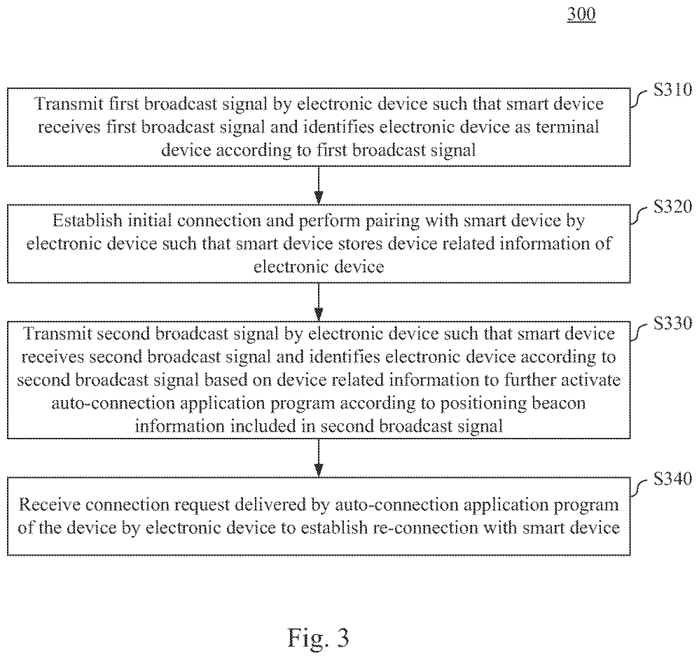

Reference is now made to FIG. 3. FIG. 3 illustrates a flow chart of a Bluetooth communication method 300 having automatic re-connection activating mechanism according to an embodiment of the present invention.

Besides the apparatus described above, the present invention further discloses the Bluetooth communication method 300 that can be used in such as, but not limited to the electronic device 110 illustrated in FIG. 1. An embodiment of the Bluetooth communication method 300 is illustrated in FIG. 3 and includes the steps outlined below.

In step S310, the first broadcast signal ADV1 is transmitted by the electronic device 110 such that the smart device 120 receives the first broadcast signal ADV1 and identifies the electronic device 110 as the terminal device according to the first broadcast signal ADV1.

In step S320, the initial connection is established and pairing is performed with the smart device 120 by the electronic device 110 such that the smart device 120 stores device related information EI of the electronic device 110. In an embodiment, during the pairing is performed, the electronic device 110 is identified by the smart device 120 as the terminal device that supports HID service.

In step S330, the second broadcast signal ADV2 is transmitted by the electronic device 110 such that the smart device 120 receives the second broadcast signal ADV2 and identifies the electronic device 110 according to the second broadcast signal ADV2 based on the device related information EI to further activate the auto-connection application program APP according to the positioning beacon information BE included in the second broadcast signal ADV2.

In an embodiment, when the smart device 120 is displaced and is far from the electronic device 110 such that the Bluetooth connection is disconnected, the smart device 120 switches from the operation mode and the sleep mode. When the smart device 120 becomes close to the electronic device 110 again and receives the second broadcast signal ADV2 transmitted by the electronic device 110 under the sleep mode, the smart device 120 identifies the electronic device 110 according to the device related information EI and further activates the auto-connection application program APP according to the positioning beacon information BE included in the second broadcast signal ADV2 under the sleep mode.

In step S340, the connection request CR delivered by the auto-connection application program APP of the smart device 120 is received by the electronic device 110 to establish the re-connection with the smart device 120.

As a result, the smart device 120 can accomplish the auto re-connection mechanism with the electronic device 110 under the sleep mode without the need to operate in the operation mode.

In practical implementation, different operation systems run by the smart device 120 and the Bluetooth connection status between the smart device 120 and the electronic device 110 may affect how the Bluetooth communication is established therebetween. A detailed operation procedure of the Bluetooth communication method corresponding to various conditions is described based on an exemplary flow in the following paragraphs.

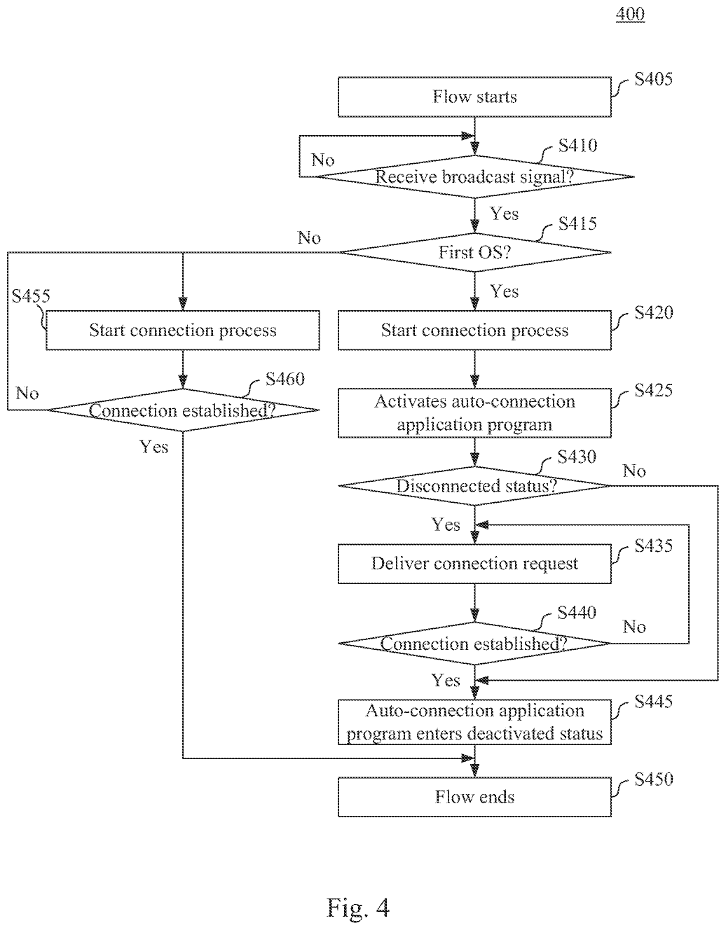

Reference is now made to FIG. 4. FIG. 4 illustrates a flow chart of a Bluetooth communication method 400 used in the smart device 120 having automatic re-connection activating mechanism according to an embodiment of the present invention. An embodiment of the Bluetooth communication method 400 is illustrated in FIG. 4 and includes the steps outlined below.

In step S405, the flow starts.

In step S410, the smart device 120 determines whether the second broadcast signal ADV2 is received. When the smart device 120 determines that the second broadcast signal ADV2 is not received, the flow goes back to step S410 to keep performing determination.

In step S415, when the smart device 120 determines that the second broadcast signal ADV2 is received, the flow determines that whether an operation system (OS) of the smart device 120 is a first operation system.

In an embodiment, a part of the manufacturers of the smart device 120 configure the smart device 120 to run a first operation system (such as but not limited to iOS operation system), in which the auto-connection application program APP run on the first operation system has a higher possibility that stops to perform re-connection after a number of failure to perform re-connection with the electronic device reaches a predetermined number so as to enter a deactivated status.

In step S420, when the operation system of the smart device 120 is the first operation system, the connection process with the electronic device 110 is started after the second broadcast signal ADV2 is received.

In step S425, the smart device 120 activates the auto-connection application program APP according to the positioning beacon information BE included in the second broadcast signal ADV2.

In step S430, the smart device 120 determines whether the Bluetooth connection status between the smart device 120 and the electronic device 110 is the disconnected status.

In step S435, when the Bluetooth connection status is the disconnected status, the auto-connection application program APP delivers the connection request CR to establish connection.

In step S440, the smart device 120 determines whether the connection is successfully established. When the smart device 120 determines that the connection is not successfully established, the flow goes back to step S440 to keep performing connection.

In step S445, when the smart device 120 determines that the connection is successfully established, the auto-connection application program APP enters the deactivated status.

When the Bluetooth connection status between the smart device 120 and the electronic device 110 is determined to be the connected status in step S430, the flow goes to step S445.

In step S450, after the auto-connection application program APP enters the deactivated status in step S445, the flow ends.

When the operation system of the smart device 120 is determined to be not the first operation system in step S415, the operation system of the smart device 120 is determined to be a second operation system.

In an embodiment, a part of the manufacturers of the smart device 120 configure the smart device 120 to run a second operation system (such as but not limited to Android operation system), in which the auto-connection application program APP run on the second operation system has a higher possibility that do not stop to perform re-connection after a number of failure to perform re-connection with the electronic device reaches a predetermined number. More specifically, the auto-connection application program APP run on the second operation system does not need to be activated according to the positioning beacon information and is activated when the broadcast signal is received.

As a result, in step S455, the connection process with the electronic device 110 starts after the second broadcast signal ADV2 is received when operation system of the smart device 120 is the second operation system.

In step S460, the smart device 120 determines whether the connection is successfully established. When the smart device 120 determines that the connection is not successfully established, the flow goes back to step S455 to keep performing connection.

When the smart device 120 determines that the connection is successfully established, the flow ends in step S455.

It is appreciated that the embodiments described above are merely an example. In other embodiments, it is appreciated that many modifications and changes may be made by those of ordinary skill in the art without departing, from the spirit of the invention.

In summary, the an electronic device and the Bluetooth communication method having automatic re-connection activating mechanism activate the automatic re-connection mechanism with the smart device under a low cost condition and further avoid the issue that the smart device stops to perform re-connection when the smart device is not connected for a long time.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A Bluetooth communication method having automatic re-connection activating mechanism, comprising:
transmitting a first broadcast signal by an electronic device such that a smart device receives the first broadcast signal and identifies the electronic device as a terminal device according to the first broadcast signal;
establishing an initial connection and performing pairing with the smart device by the electronic device such that the smart device stores device related information of the electronic device;
transmitting a second broadcast signal by the electronic device such that the smart device receives the second broadcast signal and identifies the electronic device according to the second broadcast signal based on the device related information to further activate an auto-connection application program according to positioning beacon information comprised in the second broadcast signal; and
receiving a connection request delivered by the auto-connection application program of the smart device by the electronic device to establish a re-connection with the smart device.

2. The Bluetooth communication method of claim 1, wherein the first broadcast signal comprises human interface device (HID) information of the electronic device such that the smart device receives the human interface device information and identifies the electronic device as the terminal device that is equipped with human interface device service.

3. The Bluetooth communication method of claim 1, wherein the device related information comprises identification information of the electronic device.

4. The Bluetooth communication method of claim 1, wherein the electronic device and the smart device establishes the initial connection and the re-connection based on a Bluetooth Low Energy (BLE) protocol.

5. The Bluetooth communication method of claim 1, further comprising:
deactivating the auto-connection application program after the smart device establishes the re-connection.

6. The Bluetooth communication method of claim 1, further comprising:
executing a predetermined function according to the re-connection by the electronic device.

7. The Bluetooth communication method of claim 1, wherein the predetermined function is an electronic locking function, an electronic unlocking function, an electronic switching on function, an electronic switching off function or a combination thereof.

8. The Bluetooth communication method of claim 1, wherein the second broadcast signal at least comprises a data type entry used to indicate the positioning beacon information and an identification code entry used to indicate the electronic device.

9. The Bluetooth communication method of claim 8, further comprising:
performing calculation actively by the electronic device to set a value of the identification code entry or setting the value of the identification code entry by receiving a calculation result of the auto-connection application program from the smart device by the electronic device.

10. The Bluetooth communication method of claim 1, wherein the connection request is delivered by the smart device when the smart device determines that a Bluetooth connection status between the electronic device and the smart device is a disconnected status.

11. An electronic device having automatic re-connection activating mechanism, comprising:
a communication circuit; and
a processing circuit configured to:
transmit a first broadcast signal by using the communication circuit such that a smart device receives the first broadcast signal and identifies the electronic device as a terminal device according to the first broadcast signal;
establish an initial connection and perform pairing with the smart device by using the communication circuit such that the smart device stores device related information of the electronic device;
transmit a second broadcast signal by using the communication circuit such that the smart device receives the second broadcast signal and identifies the electronic device according to the second broadcast signal based on the device related information to further activate an auto-connection application program according to positioning beacon information comprised in the second broadcast signal; and
receive a connection request delivered by the auto-connection application program of the smart device by using the communication circuit to establish a re-connection with the smart device.

12. The electronic device of claim 11, wherein the first broadcast signal comprises human interface device information of the electronic device such that the smart device receives the human interface device information and identifies the electronic device as the terminal device that is equipped with human interface device service.

13. The electronic device of claim 11, wherein the device related information comprises identification information of the electronic device.

14. The electronic device of claim 11, wherein the electronic device and the smart device establishes the initial connection and the re-connection based on a Bluetooth Low Energy protocol.

15. The electronic device of claim 11, wherein the processing circuit is further configured to:
deactivate the auto-connection application program after the smart device establishes the re-connection.

16. The electronic device of claim 11, wherein the processing circuit is further configured to:
execute a predetermined function according to the re-connection by the electronic device.

17. The electronic device of claim 11, wherein the predetermined function is an electronic locking function, an electronic unlocking function, an electronic switching on function, an electronic switching off function or a combination thereof.

18. The electronic device of claim 11, wherein the second broadcast signal at least comprises a data type entry used to indicate the positioning beacon information and an identification code entry used to indicate the electronic device.

19. The electronic device method of claim 18, wherein the processing circuit is further configured to:
perform calculation actively by the electronic device to set a value of the identification code entry or set the value of the identification code entry by receiving a calculation result of the auto-connection application program from the smart device by the electronic device.

20. The electronic device of claim 11, wherein the connection request is delivered by the smart device when the smart device determines that a Bluetooth connection status between the electronic device and the smart device is a disconnected status.
